(19) United States
(12) Patent Application Publication
(10) Pub. No.: US 2014/0051153 A1
(43) Pub. Date: Feb. 20, 2014

(54) PROCESS FOR THE DESTRUCTION OF ORGANICS IN BAYER PROCESS STREAMS

(71) Applicants: Anthony John McKinnon, South Perth (AU); Christopher Lawrence Baker, Rossmoyne (AU)

(72) Inventors: Anthony John McKinnon, South Perth (AU); Christopher Lawrence Baker, Rossmoyne (AU)

(73) Assignee: Alcoa of Australia Limited, Booragoon (AU)

(21) Appl. No.: 13/979,222

(22) PCT Filed: Dec. 16, 2011
(86) PCT No.: PCT/AU2011/001636

§ 371 Date: Nov. 1, 2013

(30) Foreign Application Priority Data
Jan. 14, 2011 (AU) 2011900131

(51) Int. Cl. C01F 7/47

(52) U.S. Cl. CPC C01F 7/473; C01F 7/476
USPC 435/262

(57) ABSTRACT

A process for the destruction of organics in a Bayer process stream, the process comprising the steps of: a) Passing a volume of a Bayer process stream to a reactor vessel in which is provided a population of a mixed bacterial culture; and b) Retaining that volume of the Bayer process stream in the reactor vessel for a period of time during which at least 10% by mass as carbon of the organic compounds destroyed originate from non-oxalate organic compounds, wherein the mixed bacterial culture comprises a mix of bacterial species capable of destroying organics and which has previously been adapted to the Bayer process stream, or a stream of substantially similar composition, prior to introduction to the reactor vessel.

### FIELD OF THE INVENTION

The present invention relates to a process for the destruction of organics in Bayer process streams. More particularly, the process of the present invention uses aerobic bacteria to destroy organics, including oxalate, and the reduction of total organic carbon content in those Bayer process streams.

### BACKGROUND ART

It is generally understood that high levels of organic carbon in Bayer process liquors reduces the alumina yield from that liquor. This phenomenon appears particularly relevant to Australian alumina refineries due to the high organic content of the bauxite feedstock.

The most common presently employed method for removal of organics in the Bayer process is liquor burning, in which a Bayer process “side stream” (a small percentage of the circulating load of a Bayer process plant) comprising a concentrated Bayer process liquor is mixed with alumina dust and passed to a kiln in which it is heated to temperatures in the order of 1000° C., thereby destroying the organics. This capital expenditure required for this process is expensive and the process may also require additional processes to mitigate potential environmental impacts.

Methods for the destruction of organics using microorganisms have been described previously. These methods have utilised specific bacterial species identified as being particularly efficacious for the destruction of oxalate. See for example Australian Patent 645065 to Worsley Alumina Pty Limited, in which a process specific for the biological disposal of oxalate is described. In that process, oxalate is degraded by use of an alkalophilic oxalate-degrading aerobic microorganism, such as a Bacillus species.

In International Patent Application PCT/CA93/00358 (WO 94/06719) to Alcan International Limited there is described the use of specific Pseudomonas genus microorganisms for the biodegradation of organics, the specific Pseudomonas genus microorganism being previously known to degrade oxalate.

Both the prior art methods referred to immediately above require the use of specific bacterial species that are operative under the specific conditions of the process described. This makes those processes difficult and costly to transport or replicate at more than one site. These processes are also particularly vulnerable to the contamination of, or loss of, a population or strain of bacteria, requiring significant time, effort and cost in re-establishing the population or strain should there be an incident that compromises the bacteria.

One object of the method and apparatus of the present invention is to substantially overcome at least some of the problems associated with the prior art described hereinabove, or to at least provide a useful alternative thereto.

The preceding discussion of the background art is intended to facilitate an understanding of the present invention only. It should be appreciated that the discussion is not an acknowledgement or admission that any of the material referred to was part of the common general knowledge in Australia as at the priority date of the application.

Throughout this specification, unless the context requires otherwise, the word “comprise”, or variations such as “comprises” or “comprising”, will be understood to, imply the inclusion of a stated integer or group of integers but not the exclusion of any other integer or group of integers.

The term “low molecular weight organics” or related terms are to be understood to include organics less than a molecular weight of about 1000. Reference to compositions of process streams in percentage terms are to be understood as reference to a percentage by volume unless stated to the contrary.

References throughout this specification to percentage, or %, by mass are to be understood as referring to the % by mass of, or as, carbon.

Additionally, references throughout the specification to amounts of, or to concentrations of, any one or more of oxalate, malonate, succinate, formate and acetate are to be understood as referring to their sodium salt, unless stated to the contrary. This is particularly to be understood to include the various examples provided in this specification.

### DISCLOSURE OF THE INVENTION

In accordance with the present invention there is provided a process for the destruction of organics in a Bayer process stream, the process comprising the steps of:
(a) Passing a volume of a Bayer process stream to a reactor vessel in which is provided a population of a mixed bacterial culture; and
(b) Retaining that volume of the Bayer process stream in the reactor vessel for a period of time during which at least 10% by mass as carbon of the organic compounds destroyed originate from non-oxalate organic compounds.
   wherein the mixed bacterial culture comprises a mix of bacterial species capable of destroying organics and which has previously been adapted to the Bayer process stream, or a stream of substantially similar composition, prior to introduction to the reactor vessel.

The process is preferably conducted in a continuous manner.

Still preferably, the volume of Bayer process stream passed to the reactor vessel is diluted prior to or during addition to the reactor vessel. The diluent may be provided in the form of a Bayer process waste water.

Still further preferably, the diluent has a TA below about 25 g/l.

Yet still further preferably, the diluent has a TC below about 15 g/L.

The diluted Bayer process stream is preferably between about 15 to 35% Bayer process stream.

Still preferably, the diluted Bayer process stream is between about 20 to 24% Bayer process stream.

Yet still preferably, the diluted Bayer process stream is about 22% Bayer process stream.

Preferably, the diluted Bayer process stream has a TA of about 69 to 90 g/L and a TC of about 52 to 66 g/L.

The pH in step (b) is preferably less than about 11.0. Still preferably, the pH in step (b) is between about 9 to 10.5.

At least about 40% by mass of non-oxalate organic carbon present is preferably destroyed in step (b). The non-oxalate organic carbon preferably comprises one or more of malonate, succinate, formate and acetate.

In one form of the invention auxiliary organic compounds may be added to the Bayer process stream prior to or during addition to the reactor vessel. This auxiliary organic compound may be sodium oxalate. Preferably, between about 10 to 60 g/L sodium oxalate is added. Still preferably, about 30 g/L sodium oxalate is added. The Applicants have discovered that adding an auxiliary organic compound can improve bioreactor performance.

In another form of the present invention an amount of effluent from a separate biological oxalate destruction process is added to the Bayer process stream prior to or during addition to the reactor vessel.

In yet another form of the present invention there is additionally provided a carbonation step. The Bayer process stream and any diluent is preferably subjected to the carbonation step. The carbonation step may be conducted concurrently with destruction of the organics in the reactor vessel.

In a still further form of the present invention there is provided an initial step in which the Bayer process stream is oxidatively treated to break down organics. The organics broken down by this initial step include organics having a molecular weight of over about 500 to 1000. Such organics may be broken down to organics of molecular weight lower than at least 1000 and which may be subsequently broken down by the bacteria in the reactor vessel. The oxidative treatment may be chemical, including treatment with peroxide or ozone for example, by increased temperature and/or pressure, or through UV treatment.

Further aspects of the invention will now be described by way of non-limiting example only, with reference to the following examples and drawings.

### BRIEF DESCRIPTION OF THE DRAWINGS

The present invention will now be described, by way of example only, with reference to one embodiment thereof and the accompanying drawings, in which:
FIG. 1 is a schematic representation of a process for the destruction of organics in Bayer process streams in accordance with the present invention.

### BEST MODE(S) FOR CARRYING OUT THE INVENTION

The process for the destruction of organics in a Bayer process stream in accordance with the present invention comprises the steps of:
(a) Passing a volume of a Bayer process stream to a reactor vessel in which is provided a population of a mixed bacterial culture; and
(b) Retaining that volume of the Bayer process stream in the reactor vessel for a period of time during which at least 10% by mass as carbon of the organic compounds destroyed originate from non-oxalate organic compounds,
   wherein the mixed bacterial culture comprises a mix of bacterial species capable of destroying organics and which has previously been adapted to the Bayer process stream, or a stream of substantially similar composition, prior to introduction to the reactor vessel.

The process is preferably conducted in a continuous manner and the volume of Bayer process stream passed to the reactor vessel is diluted prior to or during addition to the reactor vessel. The diluent may be provided in the form of a Bayer process waste water.

Still further preferably, the diluent has a TA below about 25 g/l.

Yet still further preferably, the diluent has a TC below about 15 g/L.

The diluted Bayer process stream is preferably between about 15 to 35% Bayer process stream.

Still preferably, the diluted Bayer process stream is between about 20 to 24% Bayer process stream.

Yet still preferably, the diluted Bayer process stream is about 22% Bayer process stream.

Preferably, the diluted Bayer process stream 20 has a TA of about 69 to 90 g/L and a TC of about 52 to 66 g/L.

The pH in step (b) is preferably less than about 11.0. Still preferably, the pH in step (b) is between about 9 to 10.5.

It is preferable that at least about 40% by mass of non-oxalate organic carbon present is destroyed in step (b). The non-oxalate organic carbon comprises one or more of malonate, succinate, formate and acetate.

In one form of the invention an amount of oxalate is added to the Bayer process stream prior to or during addition to the reactor vessel. Preferably, between about 10 to 60 g/L oxalate is added. Still preferably, about 30 g/L is added.

In another form of the present invention an amount of effluent from a separate biological oxalate destruction process is added to the Bayer process stream prior to or during addition to the reactor vessel.

In yet another form of the present invention there is additionally provided a carbonation step. The Bayer process stream and any diluent is preferably subjected to the carbonation step. The carbonation step may be conducted concurrently with destruction of the organics in the reactor vessel.

In a still further form of the present invention there is provided an initial step in which the Bayer process stream is oxidatively treated to break down organics having a molecular weight of over about 500 to 1000 to organics of molecular weight lower than at least 1000 and which may be subsequently broken down by the bacteria in the reactor vessel. The oxidative treatment may be chemical, including treatment with peroxide or ozone for example, by increased temperature and/or pressure, or through. UV treatment.

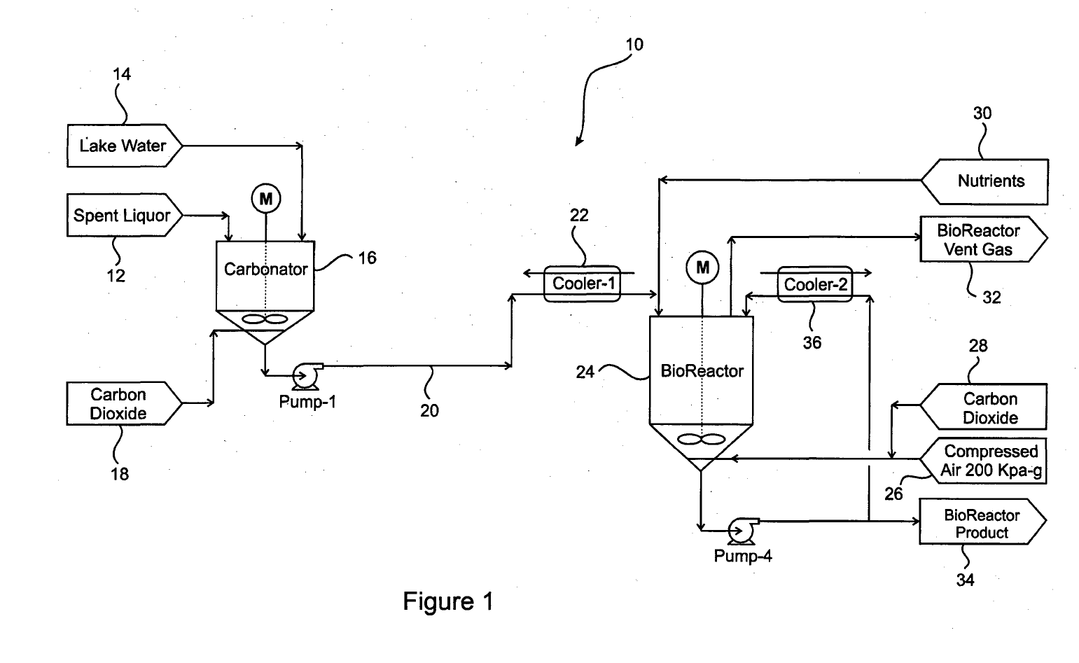

One embodiment of the invention will now be described with reference to FIG. 1, in which is shown a process 10 for the destruction of organics in Bayer process streams. The process 10 comprises the dilution of a Bayer process stream 12 with a volume of lake water 14 in a carbonator 16. The lake water 14 has a TA of less than about 25 g/L, a TC of below about 15 g/L and a pH of greater than about 13.5.

The carbonator 16 is agitated and sparged with carbon dioxide 18.

A carbonated, diluted Bayer process stream 20 is pumped from the carbonator 16 to a cooling step 22, from which it is passed to a bioreactor, for example a reactor vessel 24. The diluted Bayer process stream 20 is between about 15 to 35% Bayer process stream 12, for example between about 20 to 24%, and preferably 22%. The diluted Bayer process stream 20 has a TA of about 69 to 90 g/L and a TC of about 52 to 66 g/L.

The reactor vessel 24 is agitated and sparged with compressed air 26, and optionally carbon dioxide 28, and is maintained at a temperature of less than about 40° C., for example between about 35 to 38° C. A nutrient stream 30 is directed to the reactor vessel 24 also. The pH within the reactor vessel 24 is between about 9 to 10.5.

The reactor vessel 24 houses a mixed population of aerobic bacteria capable of destroying or decomposing low molecular weight organic carbon compounds, including oxalate, malonate, succinate, formate and acetate. The mixed population of aerobic bacteria provided in the reactor vessel 24 has previously been adapted to the Bayer process stream 20 or a stream with substantially similar characteristics, having originally been identified as a organic carbon compound destroying bacterial culture. No particular effort is made to isolate specific known organic carbon compound destroying bacterial species, the process of adaptation to the Bayer process stream or similar being used to ensure that the mixed culture is capable of effectively destroying organic compounds in the conditions that favour such destruction.

The Applicants have determined that bioreactors directed to the destruction of organic carbon may be started with secondary sewage sludge, compost, manure and septic tank treatment materials. It is envisaged that similar materials may be utilised as starting materials for the reactor vessel 24 of the present invention. Chicken manure in particular is understood to be a particularly effective source of bacteria whilst also providing an effective balance of nutrients and trace elements.

Work has been conducted on the characterisation of the bacterial populations of bioreactors directed to the treatment of oxalate containing wastes, see for example McSweeney, N. J., J. J. Plumb, A. L. Tilbury, H. J. Nyeboer, M. E. Sumich, A. J. McKinnon, P. D. Franzmann, D. C. Sutton, and A. H. Kaksonen. 2010. Comparison of microbial communities in pilot-scale bioreactors treating Bayer liquor organic wastes. Published on-line in Biodegradation DOI 10.1007/s10532-010-9412-6. This publication highlights that members of the α, β, and γ-Proteobacteria sub-groups were prominent. Further, several strains of Halomonas had been isolated, including Halomonas nitritophilus and Halomonas salina. It is envisaged by the Applicants that the bacterial populations of the bioreactors of the present invention will not differ substantially from those of the oxalate destruction processes of the prior art, albeit that the specific make up of the bacterial populations will ultimately be determined to a large extent by the starting materials and the adaption process undertaken.

A gas 32 produced through the aerobic organic carbon destruction process is vented from the reactor vessel 24.

The diluted Bayer process stream 20 may further comprise effluent from an oxalate bioreactor. In such a case the composition is about 15 to 35% Bayer process stream 12, 10 to 25% oxalate bioreactor effluent, the remainder being lakewater diluent.

The Bayer process stream 20 is retained in the reactor vessel 24 for a retention time of between about 10 to 40 hours, for example about 19 hours. A product 34 from the reactor vessel 24 may be recirculated in part through a cooling step 36 to the reactor vessel 24 so as to maintain the temperature therein to below about 40° C.

It is envisaged that at least a portion of the Bayer process streams 12 or 20 may be decomposed prior to introduction to the reactor vessel 24 so as to increase the level of organic carbon destruction within the reactor vessel 24. It is further envisaged that organic carbon levels may be further reduced by treatment of the product 34 of the reactor vessel 24, possibly with lime, process mud or an external adsorption material (not shown). Such further treatment may be directed to reducing levels of organics having a molecular weight of greater than about 1000, such as by way of absorption.

The product 34 of the reactor vessel 24 that is not recirculated is causticised before re-entering the Bayer process (not shown).

It is envisaged that any process stream having a TA lower than about 30 g/L may be used for dilution. Further, fresh water may be utilised.

In a further form of the present invention auxiliary organic compounds may be added to the Bayer process stream prior to or during addition to the reactor vessel. This auxiliary organic compound may be sodium oxalate. Between about 10 to 60 g/L sodium oxalate is added. Still preferably, about 30 g/L sodium oxalate is added. The Applicants have discovered that adding an auxiliary organic compound can improve bioreactor performance.

In another form of the present invention an amount of effluent from a separate biological oxalate destruction process is added to the Bayer process stream prior to or during addition to the reactor vessel.

The following non-limiting examples are intended to assist in the understanding of the parameters of the present invention.

### EXAMPLE 1

A mechanically agitated bioreactor was used in this trial had a working volume of 150 litres, was internally baffled and, has a working height/diameter ratio of approximately 1.1:1. Agitation was effected by a Lightnin A315 up-pumping impeller operating with a stirring speed of 600 RPM. Air was introduced via a single 2 mm sparge hole directly below the impeller. The air flow was controlled to typically maintain a dissolved oxygen (DO) concentration above 1.5 mg/L. In order to maintain the bioreactor pH below 10, for this specific example, CO₂ was introduced in the air feed line. A source of nitrogen, phosphorous and magnesium was added to the bioreactor to provide nutrients for the bacteria. An antifoam solution was also added to control foaming. An existing bacterial organic destruction process was used as a source of bacteria to start the bioreactor trials.

A number of different feed streams where trialled in this work to determine which feed streams were potentially suitable for further development in accordance with the present invention.

Lakewater Feed Stream

One of the simplest organic carbon feed streams is undiluted lakewater. In this work Kwinana lakewater (TA 22.8, TC 13.7 g/L) was fed directly into the bioreactor at flow rates varying from 5.8 to 9.0 L/hr. Typical results when operating with this feed stream are shown in Table 1 below. It can be seen that effectively all the malonate, succinate and acetate were destroyed; along with a proportion of the oxalate and formate. Overall, 32% by mass of the incoming organic carbon was destroyed. Modelling suggests that a lakewater feed bioreactor, with a volume of 270 kL, and a residence time of 19 hours, would destroy approximately 0.18 tpd organic carbon per bioreactor. This level of organic carbon destruction for an installation of this size is relatively low. Whilst not wishing to be bound by theory, the Applicants expect that this may be linked to the relatively low amount of potential food available to the bacteria when operating with a lakewater feed stock.

TABLE 1
Typical organic organic concentrations in the feed and exit streams
of a bioreactor operating with a Kwinana lakewater feed

| | | | | | | Organic |
|---|---|---|---|---|---|---|
| | Oxalate | Malonate | Succinate | Formate | Acetate | Carbon |
| Stream | (g/L) | (g/L) | (g/L) | (g/L) | (g/L) | (g/L) |
| Feed | 0.85 | 0.17 | 0.11 | 0.15 | 0.74 | 1.64 |
| Exit | 0.62 | 0.00 | 0.00 | 0.07 | 0.02 | 1.12 |

### EXAMPLE 2

Refinery Liquor and Lakewater Feed Stream

The bioreactor described in Example 1 was provided with a feed stream containing a mixture of Kwinana Crystalliser Feed (CF) liquor with Kwinana lakewater. The feed flow to the bioreactor was maintained at 7.8 L/hr while the proportion of Crystalliser Feed liquor in the feed stream was steadily increased, until a point was reached where the amount of organic carbon exiting the bioreactor in the effluent stream increased. CF liquor is spent Bayer process liquor that has been evaporated by 10 to 15%, thereby raising its TA and impurity levels. The TA levels in the CF liquor were about 280 g/L whilst TC levels were about 230 g/L.

At the point of maximum organic destruction the feed stream contained approximately 30% Crystalliser Feed liquor and 70% lakewater. At this point almost all of the low molecular weight (LMW) organics (oxalate, formate, succinate, malonate; acetate) entering the bioreactor were being destroyed and the total amount of organic carbon destroyed was 57% by mass of that entering the bioreactor, refer to Table 2 below. The amount of organic carbon destroyed that could be attributed to the measured LMW organic compounds (oxalate, formate, succinate, malonate, acetate) was 1.90 g/L or 23% by mass of the total organic carbon. Thus 34% of the organic carbon destroyed was not identified but is believed to be low and medium molecular weight organic compounds.

When the feed stream was increased to 33% Crystalliser Feed liquor, the amount of measured LMW organics destroyed increased to 2.17 g/L or 24% by mass of the total organic carbon, but the amount of unidentified organic carbon destroyed had decreased to 25% by mass. It is believed that the organic carbon destruction dropped at this point due to the high TA of the feed stream (>100 g/L).

From the above data, whilst not wishing to be bound by theory, it appears that bioreactor performance is best assessed using total organic carbon measurements as opposed to measurements of individual, or subsets of, low molecular weight organic compounds alone.

TABLE 2
Organic concentrations in the feed and exit streams of a bioreactor operating
with a mixture of Kwinana crystallizer feed (CF) and lakewater.

| | | | | | | | | Organic |
|---|---|---|---|---|---|---|---|---|
| | | | | | | | Organic | Carbon |
| | | Oxalate | Malonate | Succinate | Formate | Acetate | Carbon | Destroyed |
| Date | Stream | (g/L) | (g/L) | (g/L) | (g/L) | (g/L) | (g/L) | (by mass) |
| 21/05 | Feed | 1.57 | 0.88 | 0.68 | 1.36 | 3.45 | 8.13 | |
| | 30% CF | | | | | | | |
| 21/05 | Exit | 0.18 | 0.00 | 0.01 | 0.03 | 0.03 | 3.52 | 57% |
| 25/05 | Feed | 1.72 | 0.99 | 0.77 | 1.55 | 3.85 | 8.94 | |
| | 33% CF | | | | | | | |
| 25/05 | Exit | 0.05 | 0.00 | 0.00 | 0.00 | 0.01 | 4.55 | 49% |

Modelling suggests that operating a mixed crystalliser and lakewater feed bioreactor, with a volume of 270 kL, and a residence time of 19 hours, would destroy approximately 1.56 tpd organic carbon per bioreactor with 30% CF and approximately 1.48 tpd organic carbon per bioreactor with 33% CF, which is significantly higher than that predicted for the lakewater only feed stream reactor described in Example 1.

### EXAMPLE 3

Oxalate Slurry and Refinery Liquor Feed Stream

Oxalate Feed Concentration 60 g/L:

The bioreactor described in Example 1 was provided initially with a bioreactor feed stream consisting of Kwinana oxalate cake slurry mixed with Kwinana lakewater with the same flow rate as in the above trials (7.8 L/hr). The total amount of organic carbon destroyed was 57% by mass of that entering the bioreactor. All of the oxalate entering the bioreactor was destroyed together with 38% of the non-oxalate organic carbon. Modelling suggests that a bioreactor with this feed composition and a volume of 270 kL, and a residence time of 19 hours would destroy 24.6 tpd oxalate and 0.47 tpd non-oxalate organic carbon.

The amount of non-oxalate organic carbon entering the bioreactor was increased by replacing some of the lakewater in the feed stream with Kwinana Crystalliser Feed liquor. The proportion of Crystalliser Feed liquor in the feed stream was steadily increased until a point was reached where a significant amount of oxalate was exiting the bioreactor in the effluent stream. At the point of maximum organic destruction the feed stream contained approximately 8% Crystalliser Feed liquor with all of the oxalate entering the bioreactor being destroyed along with 46% by mass of the non-oxalate organic carbon. Modelling suggests that a bioreactor with this feed composition and a volume of 270 kL, with a residence time of 19 hours would destroy 20.5 tpd oxalate and 0.8 tpd non-oxalate organic carbon, of which 18% by mass would originate from compounds that were not sodium oxalate.

Further increases in the proportion of Crystalliser Feed liquor in the feed stream resulted in a significant amount of oxalate exiting the bioreactor and reductions in the amount of non-oxalate organic carbon destroyed.

Further trials were performed with lower levels of oxalate in an attempt to improve the level of non-oxalate organic carbon destruction.

Oxalate Feed Concentration 10 g/L:

In these trials the initial feed stream consisted of 22% Kwinana Crystalliser Feed liquor mixed with a small amount of Kwinana oxalate cake and Kwinana lakewater to give a total oxalate concentration of approximately 10 g/L. The feed flow was increased steadily up to 6.6 L/hr (Feed 5/08 in Table 3 below). The results in Table 3 below show that substantially all the measured LMW organics were destroyed including oxalate and 56% by mass of the non-oxalate organic carbon was destroyed. At this point the amount of Kwinana Crystalliser Feed liquor in the feed stream was increased to 24% to increase the organic carbon load to the bioreactor. The results in Table 3 for the feed stream on the 9/08 (7.44 L/hr) show generally complete destruction of the measured LMW organics including oxalate and an overall non-oxalate organic carbon destruction of 59% by mass.

TABLE 3
Organic concentrations in the feed and exit streams of a bioreactor operating
with a mixture of Kwinana crystallizer feed (CF), oxalate slurry and lakewater.

| | | | | | | | | non-Ox |
|---|---|---|---|---|---|---|---|---|
| | | | | | | | non-Ox | Organic |
| | | | | | | | Organic | Carbon |
| | | Oxalate | Malonate | Succinate | Formate | Acetate | Carbon | Destroyed |
| Date | Stream | (g/L) | (g/L) | (g/L) | (g/L) | (g/L) | (g/L) | (by mass) |
| 5/08 | Feed | 9.25 | 0.75 | 0.58 | 1.21 | 2.92 | 7.21 | |
| | 22% CF | | | | | | | |
| 5/08 | Exit | 0.00 | 0.00 | 0.00 | 0.04 | 0.00 | 3.17 | 56% |
| 9/08 | Feed | 9.15 | 0.82 | 0.63 | 1.35 | 3.20 | 7.72 | |
| | 24% CF | | | | | | | |
| 9/08 | Exit | 0.00 | 0.00 | 0.00 | 0.07 | 0.02 | 3.19 | 59% |
| 12/08 | Feed | 8.99 | 0.78 | 0.60 | 1.28 | 3.06 | 7.37 | |
| | 24% CF | | | | | | | |
| 12/08 | Exit | 0.19 | 0.00 | 0.00 | 0.24 | 0.02 | 3.73 | 49% |
| 17/08 | Feed | 7.97 | 0.85 | 0.67 | 1.41 | 3.30 | 7.77 | |
| | 24% CF | | | | | | | |
| 17/08 | Exit | 5.29 | 0.00 | 0.00 | 0.62 | 0.03 | 4.96 | 36% |
| 24/08 | Feed | 6.84 | 0.81 | 0.63 | 1.34 | 3.14 | 7.46 | |
| | 24% CF | | | | | | | |
| 24/08 | Exit | 6.38 | 0.00 | 0.01 | 0.06 | 0.02 | 4.69 | 37% |

The flow was increased to 9.4 L/hr and the results for the 12/08 sample (Table 3) showed a slight decrease in the amount of measured LMW organics destroyed but a significant decrease in the total amount of non-oxalate organic carbon destroyed including a significant decrease in the amount of unidentified organic carbon destroyed (39% (9/08) to 29% (12/08) by mass). Continued operation under these conditions resulted in a steady drop in oxalate destruction, with a corresponding drop in overall organic carbon destruction. The results from the feed stream on 17/08 demonstrate that there is only limited oxalate destruction and the non-oxalate organic carbon destruction has dropped to 36% by mass. Subsequent decreases in feed flow to 7.0 L/hr, over a further week of bioreactor operation, failed to increase either the amount of oxalate destruction or the amount of non-oxalate organic carbon destruction (Feed 24/08 in Table 3). From this result it appears that this organic carbon biodestruction process does not readily recover from disruptions.

The results in Table 4 below show the amount of non-oxalate organic carbon destruction and the amount of oxalate destruction expected in a full scale bioreactor for various operating conditions in this trial. The best non-oxalate organic carbon destruction achieved is just below 1.5 tpd. The results for the feed samples on 12/08 show identical organic carbon destruction levels as that of the feed sample on 9/08, even though the % by mass non-oxalate organic carbon destruction is lower, due to its higher feed flow rate. As stated above, these higher feed flow rates were not sustainable.

TABLE 4
The amount of non-oxalate organic carbon destruction and
oxalate destruction for a 270 kL bioreactor when operating under
various conditions.

| | | non-Ox | | |
|---|---|---|---|---|
| | | Organic | | |
| | | Carbon | non-Ox Organic | Oxalate |
| | | Destroyed | Carbon destruction | destruction |
| Date | Stream | (by mass) | (270 kL) | (270 kL) |
| 5/08 | Feed 22% | 56% | 1.16 tpd | 2.65 tpd |
| | CF | | | |
| 9/08 | Feed 24% | 59% | 1.46 tpd | 2.94 tpd |
| | CF | | | |
| 12/08 | Feed 24% | 49% | 1.47 tpd | 3.65 tpd |
| | CF | | | |
| 17/08 | Feed 24% | 36% | 1.15 tpd | 1.10 tpd |
| | CF | | | |

### EXAMPLE 4

Oxidative Treatment of Bayer Process Stream

An undiluted CF liquor was heated to 165° C. and held for 60 minutes in the presence of oxygen (1000 KPa) with stirring (wet oxidation treatment). At the completion of this period the liquor was cooled, diluted 1:5 with water, to an appropriate concentration, and then treated in a bioreactor. It was found that the organic carbon, oxalate, formate, succinate, acetate and malonate concentration were all significantly decreased after treatment in the bioreactor.

TABLE 5

| | Organic | | | | | | |
|---|---|---|---|---|---|---|---|
| | Carbon | Oxalate | Formate | Malonate | Succinate | Malonate | Acetate |
| | (g/L) | (g/L) | (g/L) | (g/L) | (g/L) | (g/L) | (g/L) |
| Untreated | 26.5 | 3.31 | 3.68 | 3.44 | 2.07 | 3.44 | 11.08 |
| 60 mins | 23.2 | 7.86 | 4.08 | 3.43 | 2.30 | 3.43 | 13.48 |
| oxidation | | | | | | | |

The results in Table 5 show liquor before and after wet oxidation treatment. The results show a small drop in organic carbon levels, but more significantly an increase in measured LMW organics, particularly oxalate, acetate and formate, which are readily destroyed by treatment in a bioreactor, as described previously hereinabove.

### EXAMPLE 5

Oxalate Feed Concentration 30 g/L:

Further trials were conducted in the bioreactor described in Example 1 where the feed stream was a mixture of 21% Pinjarra oxalate thickener discharge, 67% Kwinana lakewater and 12% potable water. The Pinjarra oxalate thickener discharge stream was a mixture of thickener overflow and thickener underflow such that the overall bioreactor feed stream had an oxalate concentration of approximately 30 g/L. Using this feed stock the bioreactor operating pH was steadily increased from an initial value of around pH 9.5 to above pH 10 by decreasing the amount of carbon dioxide that was added to the bioreactor. The results in Table 6 show the amount of oxalate and non-oxalate organic carbon destruction that was achieved when operating at pH 10.0. The results show complete oxalate destruction and over 60% by mass non-oxalate organic carbon destruction. The ability to operate at a pH of approximately 10.0 and above is envisaged to provide a significant operating cost advantage due to lower carbon dioxide demands and lower lime requirements if the bioreactor exit stream is causticised.

TABLE 6
The amount of non-oxalate organic carbon and oxalate destruction for a bioreactor
with a feed stream of 21% Pinjarra oxalate thickener, 67% Kwinana lakewater and
12% potable water operating at pH 10.0 with a residence time of 20 hours

| | Feed | | | non-Ox | | non-Ox |
|---|---|---|---|---|---|---|
| | non-Ox | | | Organic | | Organic |
| | Organic | Feed | Oxalate | Carbon | Oxalate | Carbon |
| | Carbon | Oxalate | Destroyed | Destroyed | Destruction | Destruction |
| Date | (g/L) | (g/L) | (by mass) | (by mass) | (270 kL) | (270 kL) |
| 23/10 | 7.46 | 34.0 | 100% | 62% | 10.9 tpd | 1.48 tpd |
| 24/10 | 7.57 | 32.3 | 100% | 63% | 10.2 tpd | 1.50 tpd |
| 25/10 | 7.52 | 32.3 | 100% | 62% | 9.9 tpd | 1.42 tpd |

### EXAMPLE 6

Results of tests conducted previously were analysed in effort to determine the level of non-oxalate organic carbon relative to total carbon destroyed by the process of the present invention relative to processes for the destruction of oxalate carbon of the prior art. The results are set out in Table 7 below. The processes directed to oxalate carbon destruction are designated as “prior art” in Table 7.

TABLE 7

| | | | Total | |
|---|---|---|---|---|
| | Carbon as | Carbon as | Organic | Non-oxalate |
| | Oxalate | non-oxalate | Carbon | Organic Carbon |
| | Destroyed | Destroyed | Destroyed | destruction* |
| Feed | (g/L) | (g/L) | (g/L) | (% by mass) |
| Oxalate Slurry | 4.3 | 0.38 | 4.68 | 8 |
| no. 1 diluted | | | | |
| with water | | | | |
| (prior art) | | | | |
| Oxalate Slurry | 3.5 | 0.3 | 3.8 | 8 |
| no. 2 diluted | | | | |
| with water | | | | |
| (prior art) | | | | |
| 30 g/L Oxalate, | 1.79 | 1.5 | 3.29 | 46 |
| 22% liquor, | | | | |
| 78% | | | | |
| Lakewater | | | | |
| 10 g/L Oxalate, | 0.6 | 1.5 | 2.1 | 71 |
| 22% liquor, | | | | |
| 78% | | | | |
| Lakewater | | | | |
| 60 g/L Oxalate, | 3.62 | 0.8 | 4.42 | 18 |
| 8% liquor, 78% | | | | |
| Lakewater | | | | |
| 30% Liquor, | 0.29 | 4.59 | 4.48 | 94 |
| 70% | | | | |
| Lakewater | | | | |

*refers to % by mass of all the organic carbon destroyed that originates from non-oxalate carbon

As can be seen above, using the processes of the prior art no greater than 8% of all organic carbon destroyed originates from non-oxalate carbon. However, using the process of the present invention the percentage of all organic carbon destroyed that originates from non-oxalate carbon is typically greater than 18% and is preferably between 46 to 94%, dependent upon the chosen make up of the feed to the bioreactor.

Modifications and variations such as would be apparent to the skilled addressee are considered to fall within the scope of the present invention.

1. A process for the destruction of organics in a Bayer process stream, comprising:
passing a volume of a Bayer process stream to a reactor vessel in which is provided a population of a mixed bacterial culture; and
retaining that volume of the Bayer process stream in the reactor vessel for a period of time during which at least 10% by mass as carbon of the organic compounds destroyed originate from non-oxalate organic compounds,
wherein the mixed bacterial culture comprises at least one of a mix of bacterial species capable of destroying organics and which has previously been adapted to the Bayer process stream and a stream of substantially similar composition, prior to introduction to the reactor vessel.

2. A process according to claim 1, wherein the process is conducted in a continuous manner.

3. A process according to claim 1, wherein the volume of Bayer process stream passed to the reactor vessel is diluted prior to or during addition to the reactor vessel.

4. A process according to claim 3, wherein the diluent is provided in the form of a Bayer process waste water.

5. A process according to claim 3, wherein the diluent has a TA below about 25 g/l.

6. A process according to claim 5, wherein the diluent has a TC of below about 15 g/L.

7. A process according to claim 3, wherein the diluted Bayer process stream is between about 15 to 35% Bayer process stream.

8. A process according to claim 7, wherein the diluted Bayer process stream is between about 20 to 24% Bayer process stream.

9. A process according to claim 8, wherein the diluted Bayer process stream is about 22% Bayer process stream.

10. A process according to claim 3, wherein the diluted Bayer process stream has a TA of about 69 to 90 g/L and a TC of about 52 to 66 g/L.

11. A process according to claim 1, wherein the pH during the retaining of that volume of the Bayer process stream in the reactor vessel is less than about 11.0.

12. A process according to claim 11, wherein the pH in step (b) is between about 9 to 10.5.

13. A process according to claim 1, wherein at least about 40% by mass of non-oxalate organic carbon present is destroyed in step (b).

14. A process according to claim 1, wherein the non-oxalate organic carbon comprises one or more of malonate, succinate, formate and acetate.

15. A process according to claim 1, wherein an amount of oxalate is added to the Bayer process stream prior to or during addition to the reactor vessel.

16. A process according to claim 15, wherein between about 10 to 60 g/L oxalate is added.

17. A process according to claim 16, wherein about 30 g/L oxalate is added.

18. A process according to claim 1, wherein an amount of effluent from a separate biological oxalate destruction process is added to the Bayer process stream prior to or during addition to the reactor vessel.

19. A process according to claim 1, further comprising a carbonation step.

20. A process according to claim 19, wherein the Bayer process stream and any diluent is subjected to the carbonation step.

21. A process according to claim 20, wherein the carbonation step is conducted concurrently with destruction of the organics in the reactor vessel.

22. A process according to claim 1, wherein the process further comprises an initial step in which the Bayer process stream is oxidatively treated to break down organics.

23. A process according to claim 22, wherein the organics broken down by the initial step Include organics having a molecular weight of between about 500 to 1000.

24. A process according to claim 22, wherein organics are broken down to organics of molecular weight lower than at least 1000 and which may be subsequently broken down by the bacteria in the reactor vessel.

25. A process according to claim 22, wherein the oxidative treatment comprises one or more of UV, chemical, temperature and/or pressure treatment.

26. A process according to claim 25, wherein the oxidative treatment comprises treatment with peroxide or ozone.

27. (canceled)

28. (canceled)
